(19) United States
(12) Patent Application Publication
(10) Pub. No.: US 2025/0083362 A1
(43) Pub. Date: Mar. 13, 2025

(54) PROCESS FOR SEPARATING MATERIALS CONSTITUTING A COMPOSITE MULTILAYER USING ACIDOPHILIC BACTERIA

(71) Applicant: COALCHRY GREEN S.R.L., Marradi (Firenze) (IT)

(72) Inventor: Alice Garau, Faenza (Ravenna) (IT)

(73) Assignee: COALCHRY GREEN S.R.L., Marradi (Firenze) (IT)

(21) Appl. No.: 18/845,434

(22) PCT Filed: Mar. 7, 2023
(86) PCT No.: PCT/IB2023/052136

§ 371 Date: Sep. 10, 2024

(30) Foreign Application Priority Data
Mar. 10, 2022 (IT) 102022000004598

(51) Int. Cl. B29B 17/02

(52) U.S. Cl. CPC B29B 17/02; B29B 2017/0213; B29B 2017/0268

(57) ABSTRACT

The present invention relates to a process for separating the layers constituting a composite multilayer. The process preferably comprises at least one step of contact, preferably by immersion, between the multilayer and a treatment mixture comprising acidophilic bacteria and optionally at least one fungus belonging to the division Ascomycota. Furthermore, the invention relates to a treatment mixture for separating the layers of a multilayer.

### FIELD OF THE INVENTION

The present invention relates to a process for separating materials constituting a composite multilayer.

### STATE OF THE ART

Disposable packaging is very widely present in the market, and is used above all for preserving, transporting and protecting foods and beverages. For the most part this packaging is made up of several layers joined together and constitutes a mass of so-called high-risk waste. Indeed, recovering the individual layers making up this packaging is very difficult and costly, in both economic and environmental terms.

In fact, the technologies used up to now have limited themselves to recovering cellulose intended for paper manufacture, whereas the components made of plastic and metal—mainly aluminium—are not recovered, or else they are recovered to a minimum extent. In most cases, composite aluminium and plastic waste material is simply crushed and used to manufacture articles. In this manner, if the aluminium is not isolated, its high value as a raw material is not exploited. There are known processes that use pyrolysis for subsequent energy generation, thus leading to the production of liquid and/or gaseous fuels. However, these processes, despite producing fuel, require a large amount of energy, which is supplied by the combustion of a part of the waste itself, as the process of pyrolysis entails an extremely endothermal reaction.

Furthermore, numerous processes have been described which use solvents, including tetrahydrofuran, caustic soda, xylene and toluene, to separate aluminium and plastic from waste packaging made of aluminised plastic. However, for the most part these processes use toxic and carcinogenic solvents that do not even allow the full recovery of aluminium in its original metal form.

Thus, there is a very felt need to have a sustainable process that does not comprise the use of polluting compounds and enables the recovery not only of cellulose, but also of the plastic and metal present in multilayer packaging.

### SUMMARY OF THE INVENTION

A first aspect of the present invention relates to a process for separating the layers constituting a composite multilayer. Preferably, the process comprises at least one step of contact, preferably by immersion, between the multilayer and a treatment mixture comprising acidophilic bacteria and optionally at least one fungus belonging to the division Ascomycota. Preferably, the bacteria and optionally the at least one fungus are dispersed in a water-based acid composition with a pH of 2.5 to 4, preferably 2.7 to 3.5. In one embodiment, the multilayer is maintained in contact with the treatment mixture for a time between 20 and 50 minutes at a temperature between 3° and 70° C., more preferably at a temperature of 40° C.

A second aspect of the present invention relates to a treatment mixture for separating the layers constituting a composite multilayer. In one embodiment, the treatment mixture comprises acidophilic bacteria and optionally at least one fungus belonging to the division Ascomycota. Preferably, the treatment mixture has a pH of 2 to 5, preferably 2.5 to 4.5. In one embodiment, the invention relates to a process for recycling a composite multilayer which comprises a step of separating the layers making up the multilayer by means of at least one step of contact, preferably by immersion, between the multilayer and a treatment mixture comprising acidophilic bacteria and optionally at least one fungus belonging to the division Ascomycota.

If the multilayer is used for packaging foods or other products, the method of the invention is a method for recycling waste packaging.

### Definitions

In the context of the present invention, “composite multilayer” or “multilayer” means a waterproof material comprising at least two layers, preferably a plurality of layers. The layers consist of different material; they are generally layers of polyethylene, paper and/or aluminium laminated together. The composite multilayer is generally, but not exclusively, used for food-grade packaging.

### DETAILED DESCRIPTION OF THE INVENTION

A first aspect of the present invention relates to a process for separating the layers constituting a composite multilayer.

In one embodiment, said multilayer comprises at least one layer, more preferably a plurality of layers of a polymeric material. Said polymeric material is preferably a thermoplastic polymer, more preferably selected from: polyethylene, polystyrene, polycarbonate, polyethylene terephthalate (PET), polyvinylchloride (PVC), polypropylene (PP) and combinations thereof.

In one embodiment, said multilayer comprises at least one layer comprising cellulose, for example paper and/or cardboard.

In one embodiment, said multilayer comprises at least one layer of polymeric material and at least one layer comprising cellulose, for example paper and/or cardboard.

In a preferred embodiment of the invention, said multilayer comprises at least one layer of polymeric material and at least one layer comprising a metal, preferably comprising aluminium.

In a preferred embodiment of the invention, said multilayer comprises at least one layer comprising cellulose, for example paper and/or cardboard, and at least one layer comprising a metal, preferably comprising aluminium.

In one embodiment, said multilayer comprises at least one layer of polymeric material, at least one layer comprising cellulose, for example paper and/or cardboard, and at least one layer comprising metal, preferably comprising aluminium.

In one embodiment, the process comprises at least one step of contact, preferably by immersion, between the multilayer and a treatment mixture comprising acidophilic bacteria and optionally at least one fungus belonging to the division Ascomycota. Preferably, the bacteria and optionally the at least one fungus are dispersed in an acid composition with a pH of 2.5 to 4, preferably 2.7 to 3.5, for example, in a fermented acid milk or an acetate.

In one embodiment, the process comprises at least one step of contacting the multilayer with the treatment mixture comprising an acid composition, preferably fermented acid milk, acidophilic bacteria belonging to at least two, preferably at least three, families selected from: Lactobacillaceae, Pseudomonadaceae, Moraxellaceae, Rhizobiacee and Acetobacteraceae; and optionally at least one fungus belonging to the family Amphisphaeriaceae and/or belonging to the family Trichocomaceae and/or belonging to the family Davidiellaceae. The multilayer is preferably maintained in contact with the mixture for a time between 2 minutes and hours at a temperature between 2° and 60° C., preferably between 3° and 45° C.

In one embodiment of the invention, the bacteria of the family Lactobacillaceae belong to the genus Lactobacillus, the bacteria of the family Pseudomonadaceae belong to the genus Pseudomonas, the bacteria of the family Moraxellaceae belong to the genus Acinetobacter, the bacteria of the family Rhizobiacee belong to the genus Rhizobium and the bacteria of the family Acetobacteraceae belong to the genus Acetobacter. The bacteria of the genus Lactobacillus preferably belong to the species L.plantarum, more preferably the bacteria of the species L.plantarum are chosen from the strains L.plantarum K21 and L.plantarum PS128.

In one embodiment, the at least one fungus belonging to the family Amphisphaeriaceae belongs to the genus Pestalotiopsis; the at least one fungus belonging to the family Trichocomaceae belongs to the genus Aspergillus and the at least one fungus belonging to the family Davidiellaceae belongs to the genus Cladosporium.

In one embodiment, the process comprises the steps of:
a) making available a treatment mixture comprising:
   an acid composition, preferably fermented acid milk,
   bacteria belonging to at least two, preferably at least three, families selected from: Lactobacillaceae, Pseudomonadaceae, Moraxellaceae, Rhizobiacee and Acetobacteraceae; and optionally
   at least one fungus belonging to the family Amphisphaeriaceae and/or belonging to the family Trichocomaceae and/or belonging to the family Davidiellaceae,
b) contacting the multilayer with the treatment mixture made available in step a) for a time between 20 minutes and 24 hours at a temperature between 2° and 80° C.

Preferably, step a) comprises the following sub-steps of:
a1) keeping milk at a temperature between 15 and 25° C. for a time between 5 and 8 days and/or until a pH of 2.5 to 4.5 is reached, preferably to 2.7 to 3.5;
a2) adding acidophilic bacteria;
a3) leaving to ferment for a time between 50 and 80 hours, at a temperature between 2° and 35° C.; and optionally a4) adding the at least one fungus.

Preferably, in step a2), the bacteria are added in an amount between 5 and 14% by weight (w/w) relative to the weight of the fermented acid milk, more preferably between 8 and 12% w/w.

The treatment mixture preferably has a pH of 2 to 5, preferably 2.5 to 4.5. In one embodiment, in step a4) the at least one fungus is mixed with a salt; said salt is preferably selected from sodium bicarbonate, potassium alum and combinations thereof. Preferably, the amount of said salt is between 2 and 8% by weight relative to the weight of the at least one fungus, preferably between 3 and 7% w/w. In one embodiment, step a4) comprises adding a solvent, for example water. Preferably, an amount of solvent, preferably water, of between 30 and 50% by weight relative to the weight of the at least one fungus is added.

The at least one fungus is preferably broken into pieces; it is preferably crumbled or chopped up.

In one embodiment, said multilayer comprises at least one layer, more preferably a plurality of layers of a polymeric material.

In one embodiment, said multilayer comprises at least one layer comprising cellulose, for example paper and/or cardboard.

In one embodiment, said multilayer comprises at least one layer of polymeric material and at least one layer comprising cellulose, for example paper and/or cardboard.

Preferably, in order to separate a multilayer comprising one or more layers of polymeric material and optionally at least one layer comprising cellulose, the treatment mixture comprises an acid composition, preferably fermented acid milk, bacteria belonging to at least two, preferably at least three, families selected from: Lactobacillaceae, Pseudomonadaceae, Moraxellaceae, Rhizobiacee and Acetobacteraceae; and at least one fungus belonging to the family Amphisphaeriaceae and/or belonging to the family Trichocomaceae and/or belonging to the family Davidiellaceae. The treatment mixture preferably has a pH of 2.5 to 4, more preferably 2.7 to 3.5.

In a preferred embodiment of the invention, said multilayer comprises at least one layer of polymeric material and at least one layer comprising a metal, preferably comprising aluminium.

In a preferred embodiment of the invention, said multilayer comprises at least one layer comprising cellulose, for example paper and/or cardboard, and at least one layer comprising a metal, preferably comprising aluminium.

In one embodiment, said multilayer comprises at least one layer of polymeric material, at least one layer comprising cellulose, for example paper and/or cardboard, and at least one layer comprising metal, preferably comprising aluminium.

Preferably, in order to separate a multilayer comprising one or more layers comprising metal and one or more layers of polymeric material and optionally at least one layer comprising cellulose, the treatment mixture comprises an acid composition, for example fermented acid milk, bacteria belonging to at least two, preferably at least three, families selected from: Lactobacillaceae, Pseudomonadaceae, Moraxellaceae, Rhizobiacee and Acetobacteraceae. The treatment mixture preferably has a pH of 2.5 to 4, more preferably 3 to 5, more preferably 3.5 to 4.5.

In a preferred embodiment of the invention, in step b) the multilayer is maintained in contact with the mixture made available in step a) for a time between 2 and 50 minutes at a temperature between 3° and 70° C., more preferably at a temperature of 40° C.-50° C. Preferably, the multilayer is immersed in the mixture.

In one embodiment, step b) is performed statically, that is, without stirring the treatment mixture and the multilayer.

Alternatively, step b) is carried out under stirring, preferably by mechanical stirring of the treatment mixture.

After step b), the materials making up the multilayer, separated from one another, are preferably recovered from the treatment mixture.

In one embodiment, after the materials making up the multilayer have been recovered, the treatment mixture is recovered and made available for further uses in a process as described above.

The Applicant has surprisingly discovered that by placing a multilayer, for example food packaging, in contact with the treatment mixture described above, one obtains the separation of the various materials making up the multilayer. In particular, the Applicant has advantageously discovered that, with the process described above, it is possible to separate layers of polymeric material, for example plastic materials, from layers of metal, for example aluminium. The various layers, separated from one another thanks to the process, can be recycled and give rise to new materials. For example, the treated and separated polyethylene can also be reused in combination with other plastic materials, thereby obtaining a stable composite plastic material.

Furthermore, the process can be applied to the entire multilayer or a residual multilayer after removal of the paper. In the latter case it is placed downstream of a recycling process at a paper mill.

In one embodiment, the invention relates to a process for recycling a composite multilayer which comprises a step of separating the layers making up the multilayer by means of at least one step of contact, preferably by immersion, between the multilayer and a treatment mixture comprising acidophilic bacteria and optionally at least one fungus belonging to the division Ascomycota. Preferably, the treatment mixture is as described in detail above.

If the multilayer is used for packaging food or other products, the method of the invention is a method for recycling waste packaging.

A second aspect of the present invention relates to a treatment mixture for separating materials constituting a composite multilayer. In one embodiment, the treatment mixture comprises acidophilic bacteria and optionally at least one fungus belonging to the division Ascomycota.

Preferably, the treatment mixture further comprises an acid composition with a pH of 2.5 to 4, preferably 2.7 to 3.5, for example, a fermented acid milk or an acetate.

In one embodiment, the treatment mixture comprises an acid composition, preferably fermented acid milk, acidophilic bacteria belonging to at least two, preferably at least three, families selected from: Lactobacillaceae, Pseudomonadaceae, Moraxellaceae, Rhizobiacee and Acetobacteraceae; and optionally at least one fungus belonging to the family Amphisphaeriaceae and/or belonging to the family Trichocomaceae and/or belonging to the family Davidiellaceae.

In one embodiment of the invention, the bacteria of the family Lactobacillaceae belong to the genus Lactobacillus, the bacteria of the family Pseudomonadaceae belong to the genus Pseudomonas, the bacteria of the family Moraxellaceae belong to the genus Acinetobacter, the bacteria of the family Rhizobiacee belong to the genus Rhizobium and the bacteria of the family Acetobacteraceae belong to the genus Acetobacter. The bacteria of the genus Lactobacillus preferably belong to the species L.plantarum, more preferably the bacteria of the species L.plantarum are selected from the strains L.plantarum K21 and L.plantarum PS128.

In one embodiment, the at least one fungus belonging to the family Amphisphaeriaceae belongs to the genus Pestalotiopsis; the at least one fungus belonging to the family Trichocomaceae belongs to the genus Aspergillus and the at least one fungus belonging to the family Davidiellaceae belongs to the genus Cladosporium.

The treatment mixture preferably has a pH of 2 to 5, preferably 2.5 to 4.5. In one embodiment, the treatment mixture has a pH of 2.7 to 3.5. In another embodiment, the treatment mixture comprising the at least one fungus has a pH of 3.5 to 4.5.

In one embodiment, the treatment mixture comprises a salt; said salt is preferably selected from sodium bicarbonate, potassium alum and combinations thereof. Preferably, the amount of said salt is between 2 and 8% by weight relative to the weight of the at least one fungus, preferably between 3 and 7% w/w. In one embodiment, the mixture comprises a solvent, for example water, in an amount between 30 and 50% by weight relative to the weight of the at least one fungus.

### Example

### Preparation of the Treatment Mixture

### Mixture 1

Fermented acid milk was prepared by leaving some milk at room temperature for about 7 days, until a pH of 2.7 to 3.5 was reached.

Acidophilic bacteria were then added in a percentage of 10% by weight relative to the weight of the fermented acid milk, and the mixture was left to ferment for about 72 hours.

The pH of the mixture 1 is between 2.7 and 3.5.

### Mixture 2

Mixture 2 was obtained by adding fungi to “mixture 1”. In detail, once the fermentation of mixture 1 was completed, fungi belonging to the genera Pestalotiopsis, Aspergillus and Cladosporium were added.

Sodium bicarbonate was then added in an amount of 5% by weight relative to the weight of the fungi, and water in an amount of 30% by weight relative to the weight of the fungi.

The pH of mixture 2 is between 3.5 and 4.5.

Mixture 1 or mixture 2 was heated at a temperature of 70° C. for 5 minutes under stirring.

The multilayer was then immersed in mixture 1 or in the mixture 2 as per the scheme illustrated in Table 1.

TABLE 1
Multilayer separation scheme

| | | Time | Immersed | |
|---|---|---|---|---|
| Mixture | ° C. | (minutes) | Multilayer | Observations |
| 1 | 40 | 30 | 1 Compact | Clean mixture - CD broken |
| | | | Disc (CD) | down into 4 parts |
| 2 | 40 | 30 | Food | Complete separation of |
| | | | packaging | layers, clean mixture, inks |
| | | | (Tetra Pak) | fixed onto the outer layer |

1. A process for separating materials constituting a composite multilayer, comprising the steps of:
(a) making available a treatment mixture comprising acidophilic bacteria belonging to at least two, families selected from Lactobacillaceae, Pseudomonadaceae, Moraxellaceae, Rhizobiaceae and Acetobacteraceae; and
(b) contacting the multilayer with the treatment mixture made available in step (a) for a time between 2 minutes and 24 hours at a temperature between 2° and 60° C.

2. The process according to claim 1, wherein the bacteria of the family Lactobacillaceae belong to the genus Lactobacillus, the bacteria of the family Pseudomonadaceae belong to the genus Pseudomonas, the bacteria of the family Moraxellaceae belong to the genus Acinetobacter, the bacteria of the family Rhizobiaceae belong to the genus Rhizobium and the bacteria of the family Acetobacteraceae belong to the genus Acetobacter.

3. The process according to claim 2, wherein the bacteria of the genus Lactobacillus belong to the species L.plantarum, selected from the strain L.plantarum K21 and L.plantarum PS128.

4. The process according to claim 1, wherein the treatment mixture has a pH of between 2.7 and 3.5.

5. The process according to claim 1, wherein the treatment mixture comprises at least one fungus belonging to the family Amphisphaeriaceae and/or belonging to the family Trichocomaceae and/or belonging to the family Davidiellaceae.

6. The process according to claim 5, wherein the at least one fungus belonging to the family Amphisphaeriaceae belongs to the genus Pestalotiopsis, the at least one fungus belonging to the family Trichocomaceae belongs to the genus Aspergillus and the at least one fungus belonging to the family Davidiellaceae belongs to the genus Cladosporium.

7. The process according to claim 5, wherein the treatment mixture has a pH between 3.5 and 4.5.

8. The process according to claim 1, wherein the multilayer comprises at least one polymeric layer and optionally a layer comprising cellulose.

9. The process according to claim 1, wherein the multilayer comprises at least one polymeric layer, at least one layer comprising a metal, and optionally a layer comprising cellulose.

10. The process according to claim 1, wherein the treatment mixture further comprises an acid composition selected from a fermented acid milk and an acetate.

11. The process according to claim 1 wherein step a) comprises the sub-steps of:
a1) keeping milk at a temperature between 15 to 25° C. for a time between 5 and 8 days and/or until a pH of 2.5 to 4 is reached;
a2) adding acidophilic bacteria;
(a3) leaving to ferment for a time between 50 and 80 hours at a temperature between 2° and 35° C.; and optionally (a4) adding the at least one fungus.

12. The process according to claim 1, wherein in step b) the multilayer is maintained in contact with the treatment mixture made available in step a) for a time between 2 and 50 minutes at a temperature between 3° and 70° C.

13. A treatment mixture comprising bacteria belonging to at least two selected from: Lactobacillaceae, Pseudomonadaceae, Moraxellaceae, Rhizobiaceae and Acetobacteraceae; wherein bacteria from the family Lactobacillaceae belong to genus Lactobacillus, bacteria from the family Pseudomonadaceae belong to genus Pseudomonas, bacteria from family Moraxellaceae belong to genus Acinetobacter, bacteria from the family Rhizobiaceae belong to genus Rhizobium and bacteria from the family Acetobacteraceae belong to genus Acetobacter.

14. The treatment mixture according to claim 13, wherein the bacteria of the genus Lactobacillus belong to the species L.plantarum, selected from the strains L.plantarum K21 and L.plantarum PS128.

15. The treatment mixture according to claim 13, comprising at least one fungus belonging to the family Amphisphaeriaceae and/or belonging to the family Trichocomaceae and/or belonging to the family Davidiellaceae.

16. The treatment mixture according to claim 15, wherein the at least one fungus belonging to the family Amphisphaeriaceae belongs to genus Pestalotiopsis, the at least one fungus belonging to the family Trichocomaceae belongs to genus Aspergillus and the at least one fungus belonging to the family Davidiellaceae belongs to genus Cladosporium.

17. The treatment mixture according to claim 13, wherein the mixture has a pH between 2.7 and 3.5.

18. The treatment mixture according to claim 13, wherein the mixture has a pH between 3.5 and 4.5.

19. The treatment mixture according to claim 13, wherein the treatment mixture further comprises an acid composition selected from a fermented acid milk and an acetate.
